(19) United States
(12) Patent Application Publication
(10) Pub. No.: US 2022/0122044 A1
(43) Pub. Date: Apr. 21, 2022

(54) SYSTEM AND METHOD FOR CREATING AND MANAGING AN OBJECT TRANSFER AND AN ASSOCIATED ONGOING THIRD PARTY RELATIONSHIP

(71) Applicant: Wells Fargo Bank, N.A., San Francisco, CA (US)

(72) Inventors: Yi M. Zhuo, Monroe, NC (US); Lin-Tine David Li, Charlotte, NC (US); Robert Christian Brantley, Winston Salem, NC (US); Chris Gerard Baker, Mooresville, NC (US); H. Brock Kolls, Alpharetta, GA (US); Regina Timmons, San Francisco, CA (US); James Albert Foulis, Charlotte, NC (US); Tambra Nichols, Charlotte, NC (US)

(21) Appl. No.: 15/638,118

(22) Filed: Jun. 29, 2017

(51) Int. Cl. G06Q 20/02; G06Q 20/10; G06Q 10/10; G06F 17/30

(52) U.S. Cl. CPC G06Q 20/027; G06F 17/30607; G06Q 10/10; G06Q 20/10

(57) ABSTRACT

A computer-implemented system and method comprising various procedures are provided for managing a transfer database. The method comprises creating in a memory, using a processor, a data object record in an object database. An asset is defined comprising an ownership transfer attribute comprising information identifying an original and transferee owner of the asset. The ownership transfer attribute also comprises a transfer condition attribute specifying a condition under which an ownership transfer of the asset is to occur, as well as a third-party benefit attribute comprising information identifying a third-party who is associated with the asset and a third-party value. The method facilitates engagement of the asset in a marketplace in which the asset may generate an asset revenue stream. The method further facilitates payment of a determined third-party amount of the asset revenue stream based on the third-party value to the third-party.

### TECHNICAL FIELD

Described herein is a system and method for creating and managing an object transfer and an associated maintenance of electronic object records to facilitate the object transfer to a third party.

### BACKGROUND

It may be desirable to transfer an object, such as an asset, from one individual to another. Such a situation may be when, for example, a benefactor desires to transfer an asset to a beneficiary. In the simple case, utilizing a database to track such an object transfer would be generally straightforward.

However, in certain instances, such an outright transfer of assets may not be desirable. In the above example situation, if the potential benefactor is unwilling or unable to accept the transfer for a variety of possible reasons, a direct transfer to the benefactor may not be beneficial.

### SUMMARY

A computer-implemented method comprising various procedures is provided for managing a transfer database. The method comprises creating in a memory, using a processor, a data object record in an object database. An asset is defined comprising an ownership transfer attribute comprising information identifying an original and transferee owner of the asset. The ownership transfer attribute also comprises a transfer condition attribute specifying a condition under which an ownership transfer of the asset is to occur, as well as a third-party benefit attribute comprising information identifying a third-party who is associated with the asset and a third-party value. The method facilitates engagement of the asset in a marketplace in which the asset may generate an asset revenue stream. The method further facilitates payment of a determined third-party amount of the asset revenue stream based on the third-party value to the third-party.

A system is provided for managing a transfer database. The system comprises a hardware processor, a storage device connected to the hardware comprising a data object record in an object database defining an asset. The asset comprises an ownership transfer attribute comprising information identifying an original and transferee owner of the asset, a transfer condition attribute specifying a condition under which an ownership transfer of the asset is to occur, and a third-party benefit attribute. The third-party benefit attribute comprises information identifying a third-party who is associated with the asset, and a third-party value. The system further comprises an asset management process executable by the processor to facilitate engagement of the asset in a marketplace in which the asset may generate an asset revenue stream, and facilitate payment of a determined third-party amount of the asset revenue stream based on the third-party value to the third-party.

A non-transitory computer-readable storage medium is provided that includes instructions that, when executed by a processor, cause the processor to execute the method procedures described above.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a flowchart that illustrates an example process that allows creating and managing an object transfer and an associated ongoing third party relationship, according to an aspect.

FIG. 2 is a block flow diagram that illustrates an example use case of the system and process, according to an aspect.

FIG. 3 is a block diagram showing an example of a computer system having a database that may operate on the system in a network environment to facilitate the above-described features, according to an aspect.

FIG. 4 is a block diagram illustrating a machine that may be a computer on which the various processes described herein may be performed, according to an aspect.

FIG. 5 is a block diagram of a distributed computing system that may be a system in which the computer(s) may operate and in which the various processes described herein may be performed, according to an aspect.

### DETAILED DESCRIPTION

When a direct object transfer to an intended recipient is not advisable or practical, it may still be beneficial to have an original intended recipient of the transfer to benefit in some way. In this situation, the object may be transferred to a different recipient while allowing the original intended recipient to maintain a third-party relationship with the object that may be beneficial for everyone. In this situation, a system and method for managing on object transfer that involves ongoing third-party relationships and activities is desirable.

Using the above example as a use case, a parent may wish to leave a house to a child but knows that the child would not benefit if the house was transferred directly to the child for any number of reasons. Although the child is the original intended recipient or beneficiary of the house, the parent may still be able to allow the child to benefit from the property even if the property is not transferred directly to the child. This may be achieved by the parent (or “original owner”) transferring the property to another transferee (or “transfer owner”) who is then designated to use the property to generate revenue, for example, by renting it out, and provide net proceeds to the child (who becomes a third party in this scenario). Thus, the child is able to benefit from the property, even though she is not the one the property was transferred to. The child still maintains a relationship with the transferred property by way of receiving the net revenue generated by it.

A further third party in this case could be a property manager who is responsible for maintaining the property and renting it out. In this case, the value of the property or the revenue stream generated by it may benefit from the expertise of an entity with expertise in dealing with a particular type of property. In this regard, it may be possible to create a database containing such manager third-party types and possibly their qualifications and ratings for dealing with particular types of property. By introducing a third-party owner before the ultimate beneficiary takes over, and based on the complexities introduced by this arrangement, an electronic “book keeping” system may be utilized to electronically monitor statuses and conditions of parties and assets, unlike in the more simple direct transfer situation.

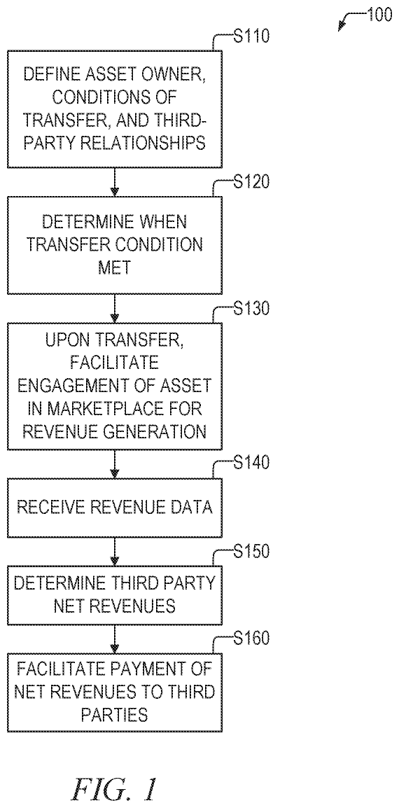

FIG. 1 is a flowchart that illustrates an example process 100 that allows creating and managing an object transfer and an associated ongoing third party relationship. In an initial operation S110, transfer information may be obtained and stored in, for example, a database. The transfer information may include information associated with the asset owner (original and transferee), conditions of the transfer, and third-party relationships.

In operation S120, a determination may be made that the transfer conditions specified in the transfer information have been met, in which case the transfer data may be updated and, in operation S130 the process may facilitate engagement of the asset in the marketplace for revenue generation. Facilitating the engagement of the asset may include a wide range of activities, for example, updating the transfer information so that a current status is available for review, communicating information to or from the original owner, transferee owner, third parties and/or other related entity, and/or setting up needed accounts.

Although the asset may be engaged in the marketplace, the beneficiary may retain at least some portion of the monetization of the asset, according to an aspect. By way of illustration, for a house that is placed into the marketplace, at least a portion of the rent revenue may go to a beneficiary. This may provide an advantage in that (e.g., for houses) an entity could be a landlord of many houses without necessarily owning the houses, permitting the landlord to control the houses without tying up capital—this notion may be extended to other types of assets (e.g., cars, boats, timeshares, etc.)

Once the asset is engaged in the market place, meaning, for example, that it is in a position to generate revenue, in operation S140, the (gross) revenue may be received. In operation S150, third-party net revenues may be determined consistent with the transfer information. In operation S160, the process may facilitate payment of the net revenues to the third parties. Facilitating payment may include actually making the payment, providing proper amounts for other payors to make such payments, and/or providing accounts into which such payments may be made.

In a situation where there are multiple beneficiaries, the marketplace concept may facilitate a beneficial split of the proceeds. For example, if the beneficiaries are family members who may be subject to an unequal split, the marketplace may mask this potentially toxic situation by making the distributions in a manner that is not transparent to the family members. Thus, while a family member has access to their own distribution, they cannot see the distributions to others.

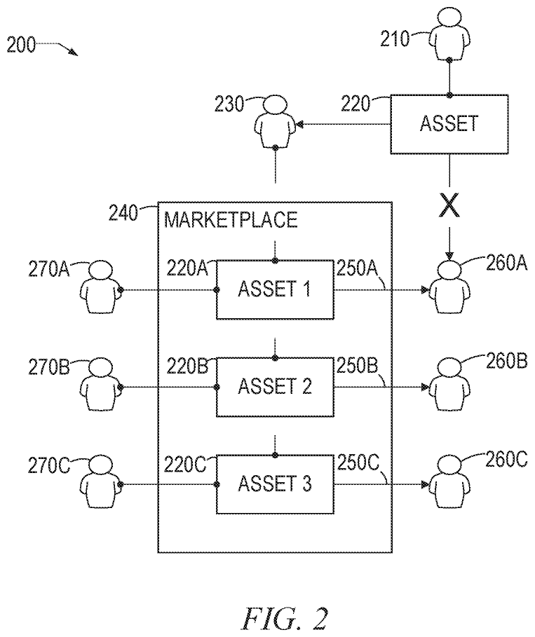

FIG. 2 is a block flow diagram that illustrates an example use case of the system and process 200 described above for engagement of an asset(s) in the marketplace. In FIG. 2, an original owner 210 who is a benefactor, identifies three third parties 260A, 260B, and 260C (numeric reference characters having letters may be designated by the numeric portion only herein to reference the reference characters collectively or representatively, for the sake of conciseness) whom she would like to benefit from an asset 220. In the present use case, the third parties 260 are benefactors who are the original owner's children. The asset (e.g., object) could be a house, an art collection, a business, or any other object of value that could potentially generate a revenue stream. In the present use case, there are three assets: real estate 220A, a business 220B, and a boat 220C. An asset 220 could, however, represent anything of value, including, but not limited to: real property, personal property, and a business.

The original owner 210 would like to leave asset 1, the real estate 220A, to the first child 260A, the business 220B to the second child 260B, and the boat 220C to the third child 260C. However, the first child 260A already owns a home and has no interest in becoming a landlord for the real estate 220A-furthermore, the first child 260A may not be able to afford the taxes or other initial costs associated with owning the real estate 220A. The second child 260B is already employed in another profession and does not desire to run the business 220B. The third child 260C is an invalid and is unable to operate the boat 220C or oversee its operation and maintenance. Therefore, the original owner 210 does not wish to create a direct transfer of these assets to her children upon a transfer condition being true, but rather would prefer to create an indirect transfer that does not necessarily burden her children with consequences that a direct transfer might entail. A transfer condition could be designated as the original owner's 210 death, incapacity, change in financial status, or any other predefined condition.

In this situation, the original owner 210 may designate a transferee owner 230 to whom ownership of the asset 220 transfers when the transfer condition becomes true. Although FIG. 2 shows the transferee owner 230 being a single owner of all of the assets 220A, 220B, and 220C, it is possible that there could be more than one transferee owner 230. There could be three separate transferee owners 230 for each separate asset 220, or one transferee owner 230 could own two assets 220 and another transferee owner 230 could own one asset 220, or multiple transferee owners 230 could jointly own a single asset 220. Put differently, there would be a many-to-many relationship between the transferee owners 230 and the assets 220.

In this system, the asset owner 230 has a responsibility to ensure that the assets are employed in the marketplace 240 to generate ongoing revenue 250 for the designated beneficiaries 260, in essence granting the beneficiaries 260 an inherited revenue stream 250. Although the transferee owner 230 may be capable of performing the role of managing the assets 220 for revenue generation himself, it is more likely that he will avail himself of third parties who are asset managers 270. These asset managers 270 are preferably those who have some level of expertise related to the asset 220 type. For example, someone with experience in being a landlord might be suited for being a manager 270A of the real estate 220A, whereas someone who operates a marina may be suited for being a manager 270C of the boat. In one configuration, the transferee owner 230 may pay the cost of taking ownership of the asset 220.

The revenue stream 250 for the assets 220 may be specified by the original owner 210. This could be specified in any manner—as an absolute amount (presuming the asset is capable of supporting that amount), as a percentage of a net value of the revenue stream, once the operating expenses have been paid, or according to any other specified payment mechanism.

In one configuration, it may be possible for a beneficiary 260 to take an initial lump sum (as an advanced revenue payment), and then reduced payments from the asset revenue stream 250 as a repayment of the advance. By way of a simple example, a house is valued at $100K. If the revenue stream is expected to be 10% or $10K/year, and the beneficiary 260 needs an initial $10K in a pre-revenue payment when the asset 220 is transferred (“loan”), the revenue stream could be split in half, such that $5000 goes to the beneficiary and $5000 goes to repayment of the $10K pre-revenue payment. Once the loan is paid back, the revenue stream returns to being $10K/year. The repayment amount based on the third-party value and/or asset revenue stream to the third-party could factor in an interest rate or an interest value, such that the repayment amount includes a principal amount and an interest amount. In that way, there may be more incentive for an original owner 210 to utilize this process, that is, that it may still be utilized to provide immediately needed revenue to a beneficiary 260. This configuration is not limited to a pre payment at the time of transfer, but could be allowed at any time, depending on the specified conditions.

In another configuration, the original owner 210 could specify whether a beneficiary 260 could ultimately acquire the asset 220 or not. In one situation, the beneficiary 260 may temporarily be unable to acquire the asset, but in the long term, the beneficiary's 260 ownership of the asset 220 is desired by the original owner 210 and the beneficiary 260. In contrast, the original owner 210 may wish for the asset 220 to be used solely for the generation of revenue, and thus preclude an ultimate transfer of the asset 220 to the beneficiary 260. The original owner 210 may specify if one of the beneficiaries 220A may cash out their revenue stream 250 to other beneficiaries 220B, 220C. The original owner 210 may also put restrictions on how the asset 220 is to be used. For example, she may specify that the real estate 220A may be used for charitable purposes, but cannot be used for a gambling casino. These may be designated in the originally specified transfer information.

Although FIG. 2 shows a one-to-one relationship between the managers 270 and the assets 220, and between the assets 220 and the beneficiaries 260, nothing precludes a many-to-many relationship, as long as it is specified.

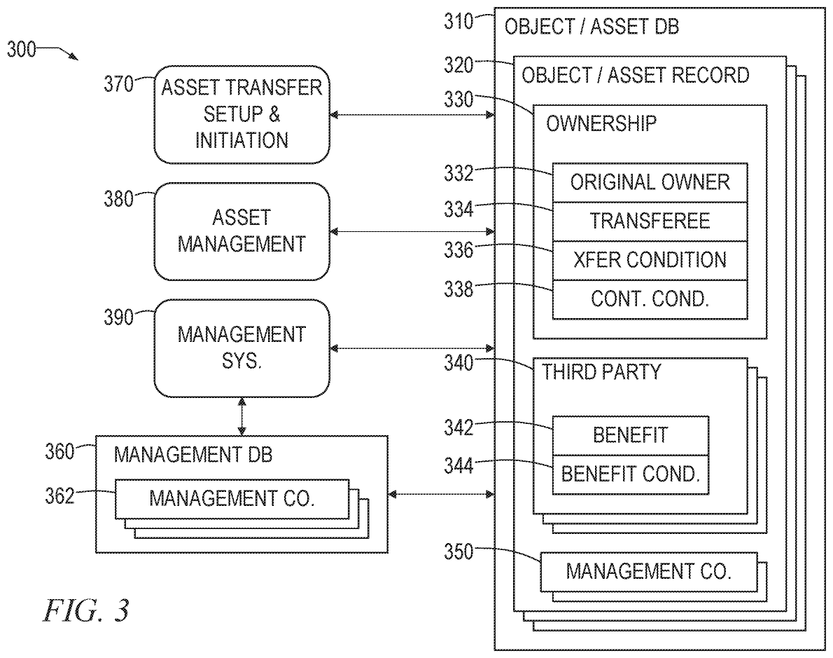

FIG. 3 is a block diagram showing an example of a computer system 300 or processor having a database that may operate on the system 300 in a network environment to facilitate the above-described features. A feature may be an object or asset database 310 that may hold a plurality of object or asset records 320. In one configuration, the asset record 320 may comprise ownership information 330, which may include information about the owners, for example, the original owner 332 and the transferee owner 334. This information could include biographical information, contact information, or any other information about the owners of relevance.

The ownership information 330 may also comprise transfer condition information 336, for example, transfer upon the original owner's 210 death, incapacity, or some change in living situation, such as moving to a nursing home.

Continued condition information 338 may also be provided that governs the ownership, revenue streams 250, and other aspects related to the asset 220 as an ongoing operation. For example, the continued condition information 338 could specify that actual ownership transfers to the beneficiaries 260 after a period of ten years or once one of the beneficiaries 260 dies or gets married. Or, it could designate that the asset be sold and the proceeds be distributed amongst the beneficiaries 260 if the asset is not capable of generating a certain amount of revenue.

The transfer condition 336 can be used by an operation such as operation S120 described above. The continued condition information 338 can be determined by a similar operation (not shown), and each may be implemented by a polling mechanism and/or an event-driven mechanism. In the polling system, a conditions-checking process loops and reviews changed data associated with any of the database entities. In an event-driven mechanism, a change in data triggers an event to a condition-checking process that considers the event's significance to the data stored in the databases. In a hybrid model, a periodic timer sends an event at a predefined interval to the condition-checking process.

The data used by the condition-checking process may be obtained in a variety of ways, including manual data entry and automated detection and entry. By way of example, one of the conditions is a transfer upon death of the original asset owner. During the normal winding up of the estate, a representative of the estate could contact a system manager to inform them of the death. The system manager could access the database and set a flag associated with the transfer upon death condition. When the system sees that the flag has been set, it may then initiate a transfer process that may automatically perform or initiate subsequent operations such as contacting an associated third party(ies), contacting a management company, creating and recording title changes, etc. In a more automated system, the determination of death could be made by automatically collecting data, such as by automatically monitoring obituaries, death announcements, and the like by, e.g., scraping/web crawling or in some other way electronically accessing news or funeral service websites, social media, city/state/federal government databases, and so on.

Similarly, for the continued condition information 338, information may be provided manually or utilizing an automated procedure. For example, a continued condition might be that the beneficiary remain in college until the year 2020 and maintain a 3.000 grade point average. In a manual-based system, the beneficiary may be required to transmit a digitized image of their report card to the system in order for the continued condition to remain being met. In an automated system, the condition may be verified by an authorized data feed directly from the college that the beneficiary is enrolled in. The mechanisms utilized to determine whether the conditions are met may be specified as a part of the object/asset record 320.

The transfer 336 and continued 338 condition information may be constructed as a set of rules that may be simple or complex. Any representation technique, such as use of the eXtensible Markup Language (XML), may be used to represent the rules or transfer conditions.

The asset record 320 may comprise third party information 340. Third parties may be the beneficiaries 260 or recipient of a designated revenue stream 250, but could also include managers 270 or other entities having a relationship with the asset 220 (information records 350 related to the management companies are shown as separate entities in the asset record 320, but they could also be structured as a part of the third party information 240). Although the original owner 210 could specify a manager 270 for an asset 220, it is also possible that the original owner 210 could leave such a decision up to the transferee owner 230. In either case, the information could be included in the database, once determined.

For a beneficiary 260, the third party information 340 may comprise benefit information 342 of the benefit conveyed, such as an absolute amount of money or a percentage of net revenue as the asset revenue stream 250. It may also specify benefit conditions 344 that include limitations. For example, the continued condition information 338 could specify that a first child 260A is to receive 25% of the revenue stream 250A until he finishes college, after which the first child 260A is to receive 50%.

In one configuration, it is possible that the original owner 210 be a beneficiary 260 as well. For example, the original owner 210 may move from her home into a nursing home, which is a triggering event. However, the original owner 210 designated themselves as a beneficiary 260, and is hence able to benefit from a generated revenue stream 250, either alone or along with other beneficiaries 260. This could perhaps cover long-term care requirements. Furthermore, the “loan” concept discussed herein could also be utilized by the original owner 210 as beneficiary 260 as well.

FIG. 3 also shows a management database 360 containing records of management companies 362. Unlike the management company records 350 for the asset record 320, the management database 360 may contain management company information for a large number of different companies 362 covering a wide variety of management expertise. In one configuration, the management database 360 may utilize a ranking system that provides a ranking of desirability for various types of assets. For example, for large boat assets, company one might have a high ranking, company two might have a middle ranking, and company three might have a low ranking—but these rankings may be reversed for small boats. The rankings could be established based on feedback received or upon information collected from external systems, such as social media and review web sites and utilize web bots, scraping techniques, database queries, or other mechanisms to acquire information. The management companies could also be tiered, for example based on high, medium, or low valued assets, which could be based on experience or other factors.

Thus, one potential beneficial feature of the system may be a management system process 390 that may be utilized to assist the original owner 210 or asset owner 230 in establishing the best manager 270 for the asset and provide the ranking and rating mechanisms for the different management companies. Over time, as the system is used more, a large collection of management companies and their respective capabilities and ratings may be obtained to provide additional value to the system. The management system process 390 in collection with the management database 360 could further benefit by providing some form of reward for good performance with an asset (or collective assets) 220. Managers who have proven themselves may be recommended for higher value assets or given other more favorable press, and command higher management fees (absolute or percentage-wise).

Similarly, an asset transfer setup and initiation process 370 may be provided to assist in the setup of and initiation of the transfer. For example, such a process 370 could help to ensure that relevant beneficiaries 260 are considered. For example, if an asset 220 is an impressionist art collection, then the process 370 could provide information of museums specializing in impressionist art as potential beneficiaries 260. The original owner 210 may then be able to review related collected information about the potential beneficiary 260 and select the beneficiary and specify the relevant information for that beneficiary as described above. The process 370 may also provide communication services, such as informing the transferee owner 230 that the transfer condition has been triggered. It could also obtain information to help assess the value of the asset 220 and assist in estimating the revenue stream 250 likely to be generated by the asset, and help to apportion the revenue stream 250 between the beneficiaries 260. For an ongoing business as an asset 220, this may be relatively straightforward by using past accounting records to infer future revenue streams. For other types of assets 220, this may involve more complex analysis tools in attempting to assets its value in the market.

An asset management process 380 could be provided to assist in managing operations related to a transferred asset, such as performing the accounting functions, operating accounts to receive revenues generated by the assets, allocate management expenses, and transfer the beneficiary revenue streams 250 to beneficiary accounts. The procedures described above may be performed by one of these processes 370, 380, 390, but the system may incorporate other processes as well.

Information may be entered into the asset database 310 and management database 360 using any mechanism for entry. For example, data entry could be provided by users interacting with a web browser-based interface that presents various forms to fill out. By way of example, the original owner of the asset could access a secure portion of a web site to enter the ownership information 330, and a representative from the management company could access a different secure portion of the web site to enter relevant information in the management database 360.

In another example, a client-server architecture may be utilized in which the relevant parties can download a client application that solicits relevant information, reformats it, and then provides the information to a server application which enters it into the relevant database 310, 360. In another example, the relevant users could simply fill out paper forms, or have a conversation with a representative who can collect the information and then perform the necessary data entry from within a secure system of the representative. Other mechanisms for entering the relevant information into the databases 310, 360 may be used as well.

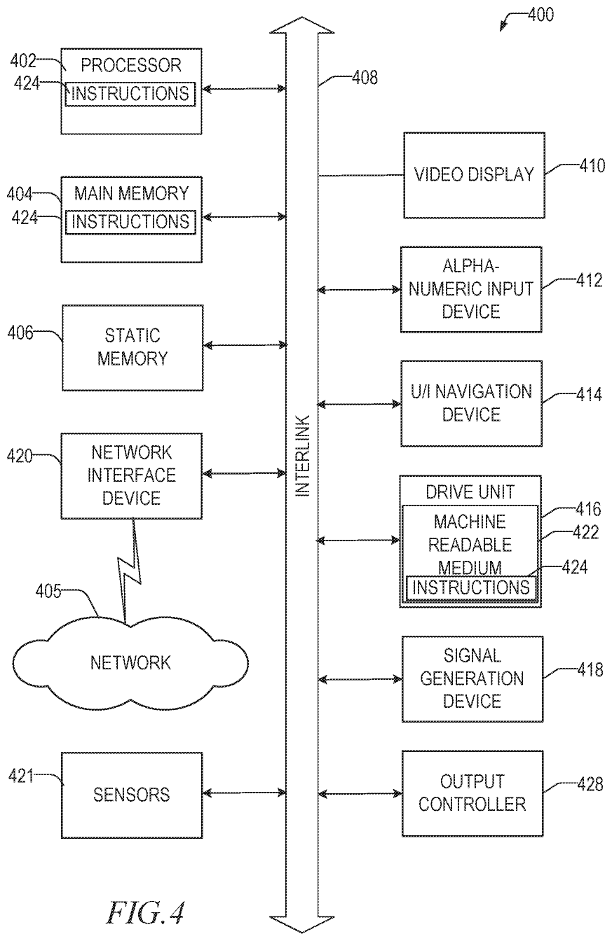

To describe some configurations in greater detail, reference is made to examples of hardware structures and interconnections usable in the designs of the present disclosure. FIG. 4 is a block diagram illustrating a machine that may be a computer on which various processes described herein may be performed, such as a processor of the system 300 described above. The machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example described herein, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 424 may further be transmitted or received over the communications network 405 using a transmission medium via the network interface device 420. The term “transmission medium” is defined herein to include any medium that is capable of storing, encoding, or carrying instructions for execution by the machine, and includes digital or analog communications signals or other medium to facilitate communication of such software.

The machine 400 may communicate with one or more other machines 400 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 400. In an example, the network interface device 420 may include one or more physical jacks (e.g., Ethernet, coaxial, or phone jacks) or one or more antennas to connect to the communications network 426.

In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

A wide variety of computing devices may constitute a machine 400, as described herein. The following list includes a variety of devices that may fit the definition of a machine 400: a personal data assistant (PDA), a cellular telephone, including a smartphone, a tablet computing device, a laptop computer, a desktop computer, a workstation, a server computer, a mainframe computer, and the like.

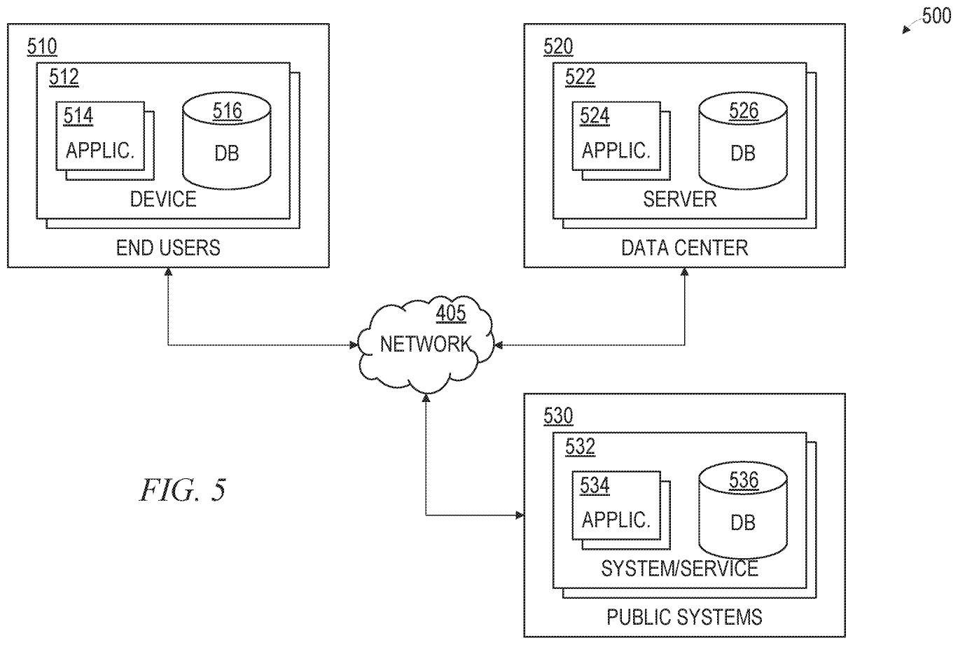

FIG. 5 is a block diagram of a distributed system 500 that may include a client-server architecture or cloud computing system. The system 500 may be a system 100 as described above. Distributed system 500 may have one or more end users 510. An end user 510 may have various computing devices 512, which may be machines 400 as described above. The end-user computing devices 512 may comprise applications 514 that are either designed to execute in a stand-alone manner, or interact with other applications 514 located on the device 512 or accessible via the network 405. These devices 512 may also comprise a data store 516 that holds data locally, the data being potentially accessible by the local applications 514 or by remote applications.

The system 500 may also include one or more data centers 520. A data center 520 may be a server 522 or the like associated with a business entity that an end user 510 may interact with. The business entity may be a computer service provider, as may be the case for a cloud services provider, or it may be a consumer product or service provider, such as a retailer. The data center 520 may comprise one or more applications 524 and databases 526 that are designed to interface with the applications 514 and databases 516 of end-user devices 512. Data centers 520 may represent facilities in different geographic locations where the servers 522 may be located. Each of the servers 522 may be in the form of a machine(s) 400.

The system 500 may also include publicly available systems 530 that comprise various systems or services 532, including applications 534 and their respective databases 536. Such applications 534 may include news and other information feeds, search engines, social media applications, and the like. The systems or services 532 may be provided as comprising a machine(s) 400.

The end-user devices 512, data center servers 522, and public systems or services 532 may be configured to connect with each other via the network 405, and access to the network by machines may be made via a common connection point or different connection points, e.g. a wireless connection point and a wired connection. Any combination of common or different connections points may be present, and any combination of wired and wireless connection points may be present as well. The network 405, end users 510, data centers 520, and public systems 530 may include network hardware such as routers, switches, load balancers and/or other network devices.

Other implementations of the system 500 are also possible. For example, devices other than the client devices 512 and servers 522 shown may be included in the system 500. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 522.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other aspects may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as aspects may feature a subset of said features. Further, aspects may include fewer features than those disclosed in a particular example. Thus, the following claims are hereby incorporated into the Detailed Description, with a claim standing on its own as a separate embodiment. The scope of the embodiments and aspects disclosed herein is to be determined with reference to the claims, along with the full scope of equivalents to which such claims are entitled.

1. A computer-implemented method for managing a transfer database, comprising:
creating in a memory, using a processor, a data object record in an object database, defining an asset comprising:
an ownership transfer attribute comprising information identifying an original owner and transferee owner of the asset;
a transfer condition attribute specifying a transfer condition under which an ownership transfer of the asset is to occur; and
a third-party benefit attribute comprising:
information identifying a third-party who is associated with the asset; and
a third-party value;
monitoring information resources for instances of the original owner to identify an event in a respective information resource related to the original owner, the transferee owner, and the asset;
in response to identification of the event, automatically contacting the respective information resource;
receiving event data from the information resource;
verifying parameters of the event based on the event data;
determining a variation to data included in the object database based on the parameters of the event;
setting the transfer condition based on the variation;
facilitating, based on satisfaction of the transfer condition, engagement of the asset in a marketplace in which the asset may generate an asset revenue stream, wherein the transfer condition is determined to have been satisfied by:
performing periodic polls for condition data from at least one source of: a news or business website, social media site, or government database, wherein a periodic poll includes performing a web crawl of a source based on identification of the event data at the source;
identifying condition data related to the event data from the periodic polls;
comparing the condition data with a rule stored in the object database to determine transfer condition satisfaction;
upon determination of transfer condition satisfaction, automatically retrieving verification data from an authorized data source associated with the transferee owner; and
verifying the condition data with the verification data;
initiating a transfer process upon satisfaction of the transfer condition, wherein the transfer process automatically initiates at least one of: contacting an associated third party, contacting a management company, creating a title change, or recording a title change; and
facilitating, based on the third-party benefit attribute, payment of a determined third-party amount of the asset revenue stream based on the third-party value to the third-party.

2. The method of claim 1, further comprising:
determining when conditions in the transfer condition attribute are true; and
performing the facilitating of the engagement when the determining is true.

3. The method of claim 1, further comprising:
modifying the third-party value in the object database and temporarily adjusting the asset revenue stream to the third-party in the third-party benefit attribute in the object database based on an initial lump sum to the third-party.

4. The method of claim 3, further comprising:
further modifying the third-party value and temporarily adjusting the asset revenue stream to the third-party based on an interest value.

5. The method of claim 1, wherein the original owner is defined as the third-party.

6. The method of claim 1, wherein the transfer condition attribute is at least one of death or incapacitation of the original owner.

7. The method of claim 1,
wherein the information resource includes at least one of: a news or business website, social media site, or government database.

8. The method of claim 7, wherein the rule is represented using an eXtensible Markup Language (XML).

9. The method of claim 7, wherein the transfer process automatically initiates at least one of: contacting an associated third party, contacting a management company, creating a title change, or recording a title change.

10. The method of claim 1, wherein the asset is at least one of real property, personal property, or a business.

11. The method of claim 1, wherein the facilitating of payment comprises transferring funds to an account of the third-party.

12. The method of claim 1, wherein the third-party amount of the asset revenue stream is further determined based on a benefit condition in the data object record.

13. The method of claim 1, wherein the third-party amount of the asset revenue stream is based on a percentage of a net value of the revenue stream.

14. The method of claim 1, further comprising:
associating with the asset, using a management system process, a manager who manages the asset to produce the revenue stream and is selected from a plurality of managers; and
maintaining the plurality of managers in a management database, wherein the associating comprises selecting the manager based on a rating or ranking of the manager related to a type of the asset.

15. The method of claim 14, wherein the rating or ranking is based on at least one of feedback, web scanning, or database scanning.

16. The method of claim 1, further comprising:
presenting to the original owner, by an asset transfer setup and initiation process, potential third parties based on comparing asset attributes with third-party attributes.

17. A system for managing a transfer database, comprising:
a hardware processor;
a storage device connected to the hardware comprising:
a data object record in an object database, defining an asset comprising:
an ownership transfer attribute comprising information identifying an original owner and transferee owner of the asset;
a transfer condition attribute specifying a transfer condition under which an ownership transfer of the asset is to occur; and
a third-party benefit attribute comprising:
information identifying a third-party who is associated with the asset; and
a third-party value;
an asset management process to:
monitor information resources for instances of the original owner to identify an event in a respective information resource related to the original owner, the transferee owner, and the asset;
in response to identification of the event, automatically contact an information resource;
receive event data from the information resource;
verify parameters of the event based on the event data;
determine a variation to data included in the object database based on the event;
set the transfer condition based on the variation;
facilitate, based on satisfaction of the transfer condition, engagement of the asset in a marketplace in which the asset may generate an asset revenue stream, wherein determining the transfer condition is satisfied includes a process to:
perform periodic polls for condition data from at least one source of: a news or business website, social media site, or government database, wherein a periodic poll includes performing a web crawl of a source based on identification of the event data at the source;
identify condition data related to the event data from the periodic polls;
compare the condition data with a rule stored in the object database to determine transfer condition satisfaction;
upon determination of transfer condition satisfaction, automatically retrieve verification data from an authorized data source associated with the transferee owner; and
verify the condition data with the verification data;
initiate a transfer process upon satisfaction of the transfer condition, wherein the transfer process automatically initiates at least one of: contacting an associated third party, contacting a management company, creating a title change, or recording a title change; and
facilitate, based on the third-party benefit attribute, payment of a determined third-party amount of the asset revenue stream based on the third-party value to the third-party.

18. The system of claim 17, wherein the asset management process is to:
determine when conditions in the transfer condition attribute are true; and
perform the facilitating of the engagement when the determining is true.

19. The system of claim 17, wherein the asset management process is to:
modify the third-party value and temporarily adjusting the asset revenue stream to the third-party based on an initial lump sum to the third-party.

20. The system of claim 17, wherein the original owner is defined as the third-party.

21. The system of claim 17, wherein the third-party amount of the asset revenue stream is further determined based on a benefit condition in the data object record.

22. A non-transitory computer-readable storage medium, the computer-readable storage medium including instructions that when executed by a processor, cause the processor to:
create in a memory a data object record in an object database, defining an asset comprising:
an ownership transfer attribute comprising information identifying an original owner and transferee owner of the asset;
a transfer condition attribute specifying a transfer condition under which an ownership transfer of the asset is to occur; and
a third-party benefit attribute comprising:
information identifying a third-party who is associated with the asset; and
a third-party value;
monitor information resources for instances of the original owner to identify an event in a respective information resource related to the original owner, the transferee owner, and the asset;
in response to identification of the event, automatically contact an information resource;
receive event data from the information resource;
verify parameters of the event based on the event data;
determine a variation to data included in the object database based on the event;
set the transfer condition based on the variation;
facilitate, based on satisfaction of the transfer condition, engagement of the asset in a marketplace in which the asset may generate an asset revenue stream, wherein determining the transfer condition is satisfied includes further instructions to:
perform periodic polls for condition data from at least one source of: a news or business website, social media site, or government database, wherein a periodic poll includes performing a web crawl of a source based on identification of the event data at the source;
identify condition data related to the event data from the periodic polls;
compare the condition data with a rule stored in the object database to determine transfer condition satisfaction;
upon determination of transfer condition satisfaction, automatically retrieve verification data from an authorized data source associated with the transferee owner; and
verify the condition data with the verification data;
initiate a transfer process upon satisfaction of the transfer condition, wherein the transfer process automatically initiates at least one of: contacting an associated third party, contacting a management company, creating a title change, or recording a title change; and
facilitate, based on the third-party benefit attribute, payment of a determined third-party amount of the asset revenue stream based on the third-party value to the third-party.

23. The storage medium of claim 22, wherein the instructions further cause the processor to modify the third-party value and temporarily adjusting the asset revenue stream to the third-party based on an initial lump sum to the third-party.
